(19) United States
(12) Patent Application Publication
(10) Pub. No.: US 2016/0119484 A1
(43) Pub. Date: Apr. 28, 2016

(54) METHOD AND SYSTEMS FOR CONTROLLING MEDIA AND SIGNALING CHANNELS OF A VOICE OVER INTERNET PROTOCOL TELEPHONY COMMUNICATION

(71) Applicant: VONAGE NETWORK LLC, Holmdel, NJ (US)

(72) Inventors: Itay Bianco, Tel-Aviv (IL); Sagie Machlin, Rishon Lezion (IL); Gil Osher, Tel-Aviv (IL)

(21) Appl. No.: 14/524,401

(22) Filed: Oct. 27, 2014

(51) Int. Cl. H04M 15/00; H04L 29/12; H04W 4/16

(52) U.S. Cl. CPC H04M 15/56; H04W 4/16; H04L 61/2007; H04W 84/042

(57) ABSTRACT

Methods and systems for controlling media and signaling channels of a Voice over Internet Protocol (VoIP) telephony communication are provided herein. In some embodiments, a method for controlling media and signaling channels of a Voice over Internet Protocol (VoIP) telephony communication may include transmitting call signaling information over a first network to establish a call between a first device and a second device; transmitting media associated with the call between the first device and the second device over a second network, wherein the first network is different from the second network; determining a third network is available for telephony communications; and transmitting the media associated with the call between the first device and the second device over the third network while the call signaling information continues to be transmitted over the first network.

### BACKGROUND

1. Field

Embodiments of the present invention generally relate to methods and systems for controlling media and signaling channels of a Voice over Internet Protocol (VoIP) telephony communication.

2. Description of the Related Art

When an Internet Protocol (IP) telephony system establishes a VoIP telephone call from a mobile device, it is common for the signaling and media streams to go through the same network interface in the mobile device. For example, if the mobile device is connected to a 3G network, both the signaling and media streams go through 3G. If the mobile device is connected to a wireless local area network (WLAN), both the signaling and media streams go through the WLAN.

Due to the fact that WLANs have a short range and cellular networks cover any place where there is mobile phone service, typically, the cellular network (e.g., 3G, 4G, LTE) is always available, or almost always available, from the mobile device while the availability of the WLAN is sporadic. When the mobile device changes location, it may move out of the range of a first WLAN and into the range of a second WLAN, while still being in range of the cellular network. Media streams use a significant amount of bandwidth while signaling does not. As such, keeping signaling and media on a same network when both types of networks are available is inefficient and costly.

Thus, there is a need for a method and system to provide a better way of controlling media and signaling channels of a Voice over Internet Protocol (VoIP) telephony communication.

### SUMMARY

Methods and systems for controlling media and signaling channels of a Voice over Internet Protocol (VoIP) telephony communication are provided herein. In some embodiments, a method for controlling media and signaling channels of a Voice over Internet Protocol (VoIP) telephony communication may include transmitting call signaling information over a first network to establish a call between a first device and a second device; transmitting media associated with the call between the first device and the second device over a second network, wherein the first network is different from the second network; determining a third network is available for telephony communications; and transmitting the media associated with the call between the first device and the second device over the third network while the call signaling information continues to be transmitted over the first network.

In some embodiments, a system for controlling media and signaling channels of a Voice over Internet Protocol (VoIP) telephony communication may include a signaling module configured to transmit call signaling information over a first network to establish a call between a first device and a second device; a media transmission module configured to transmit media associated with the call between the first device and the second device over a second network, wherein the first network is different from the second network, determine a third network is available for telephony communications; and a network analysis/routing module configured to transmit the media associated with the call between the first device and the second device over the third network while the call signaling information continues to be transmitted over the first network.

In some embodiments, a computer readable medium is disclosed. The computer readable medium stores computer instructions that, when executed by at least one processor causes the at least one processor to perform the method for controlling media and signaling channels of a Voice over Internet Protocol (VoIP) telephony communication.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a mobile device for controlling media and signaling channels of a Voice over Internet Protocol (VoIP) telephony communication, according to one or more embodiments;

FIG. 3 depicts a flow diagram of a method for controlling media and signaling channels of a Voice over Internet Protocol (VoIP) telephony communication, according to one or more embodiments; and

FIG. 4 depicts a computer system that can be utilized in various embodiments of the present invention, according to one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods and systems for controlling media and signaling channels of a Voice over Internet Protocol (VoIP) telephony communication. More specifically, when a call is initiated, the call signaling information is transmitted through a cellular network or similar type of network that is considered to be always on or almost always on, such as EDGE, 3G, 4G, and the like. If a wireless local area network (WLAN) is available, the media for the call is transmitted through the WLAN. If no WLAN is available, the media is sent through the cellular network until a WLAN becomes available. At such time as the WLAN becomes available, the media is sent through the WLAN, but the signaling continues to be transmitted on the cellular network. As the mobile device changes location, the device may move into the range of a new WLAN. The media for the call is moved to the new WLAN, but the call signaling information continues to be transmitted on the cellular network. Advantageously, the bandwidth heavy media remains on the WLAN whenever possible, while the low data signaling remains on the cellular network.

Although the present disclosure is described using WLAN as the wireless short range network, those skilled in the art will appreciate that the present invention may be implemented in response to a change in any short range wireless network, such as Bluetooth, Radio Frequency (RF), and the like. In addition, the present invention may be used in the exemplary embodiment where a phone is connected through a Universal Serial Bus (USB) cable to a laptop computer where the laptop computer has its own cellular network. Although the phone is connected through a wired connection, when disconnected the phone may be required to move to a wireless network.

Although the present disclosure describes the invention using an exemplary embodiment of forwarding data packets bearing the media of a Voice over Internet Protocol (VoIP) telephony communication, one skilled in the art can appreciate that the present invention may be used for any session-based IP communication that has a signaling channel, a media channel, and a media relay, such as Internet Relay Chat (IRC), Simple Mail Transfer Protocol (SMTP), and the like or additionally for use in resumable file download or one-way video streaming.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical, electronic, or magnetic quantities within memories, registers, or other information storage devices, transmission devices, or display devices of the special purpose computer or similar special purpose electronic computing device.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

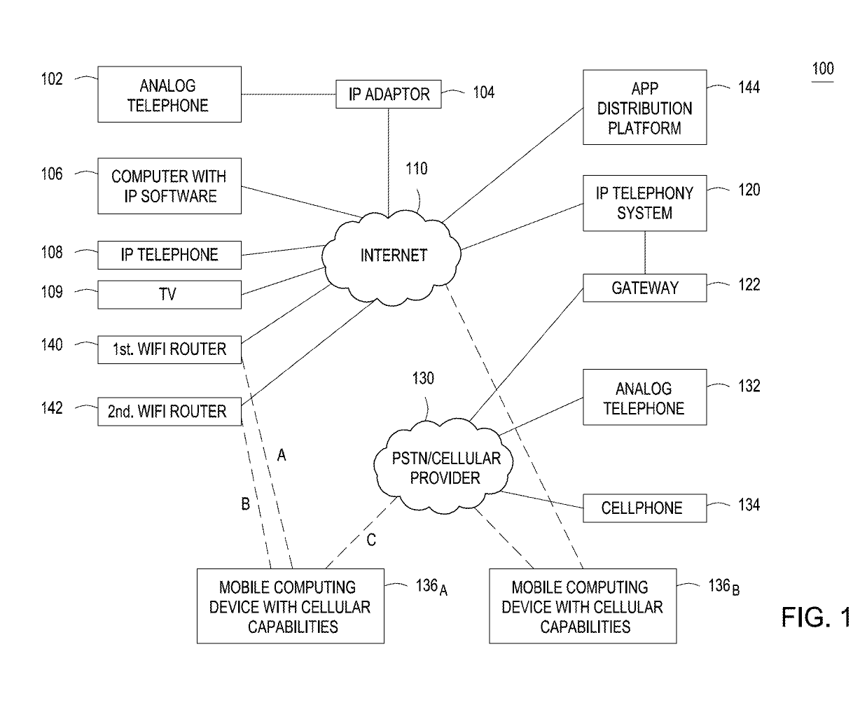

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may be provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected to one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a wireless local area network (WLAN) router based on the Institute of Electrical and Electronics Engineers' (IEEE) 802.11 and 802.13 standards. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the wireless local area network (WLAN) based on the Institute of Electrical and Electronics Engineers' (IEEE) 802.11 and 802.13 standards.

Similarly, mobile computing device with cellular capabilities 136B may also be coupled to internet 110 and/or cellular service provider 130. In some embodiments, mobile computing device 136B may be connected to internet 110 via a wireless local area network (WLAN) based on the Institute of Electrical and Electronics Engineers' (IEEE) 802.11 and 802.13 standard connection, and the like, and can also establish a VOIP telephone call with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

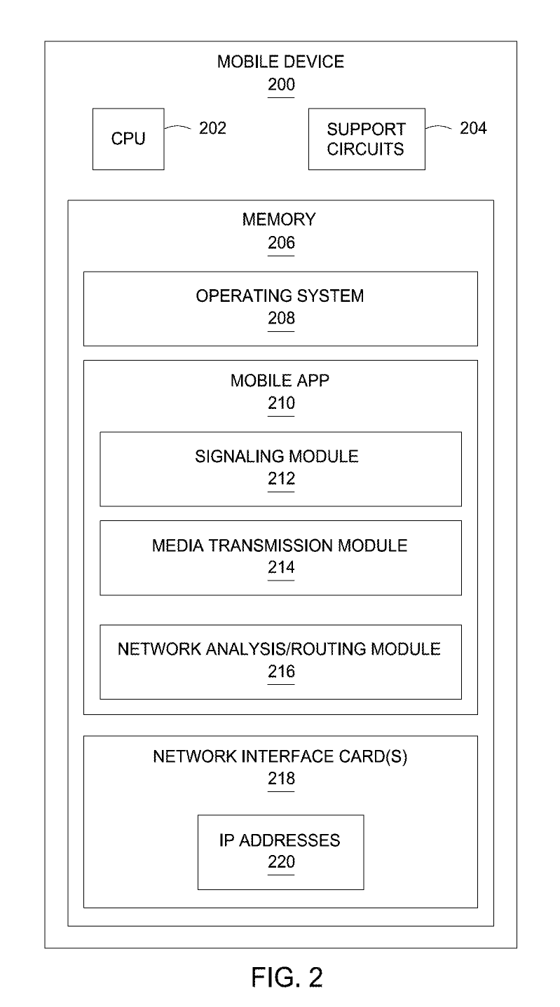

FIG. 2 depicts a block diagram of a mobile device 200 for controlling media and signaling channels of a Voice over Internet Protocol (VoIP) telephony communication, according to one or more embodiments. In some embodiments, mobile device 200 may be a mobile computing device (e.g., 136A) associated with a user using the IP telephony system 120 as described above in FIG. 1.

Mobile device 200 may comprise a Central Processing Unit (CPU) 202, support circuits 204, and memory 206. The CPU 202 may comprise one or more commercially available microprocessors or microcontrollers that facilitate data processing and storage. The various support circuits 204 facilitate the operation of the CPU 202 and include one or more clock circuits, power supplies, cache, input/output device and circuits, and the like. The memory 206 comprises at least one of Read Only Memory (ROM), Random Access Memory (RAM), disk drive storage, optical storage, removable storage and/or the like. In some embodiments, the memory 206 comprises an operating system 208, a mobile app 210, such as a mobile telecommunication app, and one or more Network Interface Cards (NICs) 218. Each NIC 218 may be associated with one or more Internet protocol (IP) addresses 220. In the event that the mobile device 200 has multiple NICs 218, the signaling and media IP addresses may be on different NICs 218. In the event that the mobile device 200 has one NIC 218, the same NIC 218 can process both the media and signaling, provided at least two IP addresses are associated with the NIC 218.

The operating system (OS) 208 generally manages various computer resources (e.g., network resources, file processors, and/or the like). The operating system 208 is configured to execute operations on one or more hardware and/or software modules, such as NICs, hard disks, virtualization layers, firewalls and/or the like. Examples of the operating system 208 may include, but are not limited to, various versions of LINUX, MAC OSX, BSD, UNIX, MICROSOFT WINDOWS, IOS, ANDROID and the like. In some embodiments, operating system 208 may include an application programming interface (API) which can be used to access device information and features (such as, for example, by mobile app 210).

In some embodiments, the mobile app 210 is a VoIP app that provides over-the-top (OTT) VoIP telephony services to an end-user. In some embodiments, an end-user may download the mobile app 210 from a service provider or an app distribution system 144, and install the mobile app 210 on the mobile device 200. Although the mobile app 210 is described herein as a separate stand-alone application, in some embodiments the mobile app 210 may be integrated into OS 208, and may use existing API calls provided by the OS 208 to access or control various features of the mobile device 200.

In some embodiments, mobile app 210 may include a signaling module 212, a media transmission module 214, and a network analysis/routing module 216. In use, when a user wishes to place a call, the mobile app 210 polls the operating system 208 for all of the IP addresses 220 that are currently available through the NICs 218. The signaling module 212 then opens a communication connection on the cellular network, or similar type of network that is considered to be always on or almost always on, for transmitting call signaling information. In some embodiments, Session Initiation Protocol (SIP) may be used to establish the call or communication session (i.e., as the call signaling information). The details and functionality of SIP can be found in the Internet Engineering Task Force (IETF) Request for Comments (RFC) Paper No. 3261 entitled, “SIP: Session Initiation Protocol,” that is herein incorporated in its entirety by reference. In some embodiments, other network protocols, such as Extensible Messaging and Presence Protocol (XMPP) or H323 may be used to establish the communication session.

The signaling module 212 opens a socket and binds it to the IP address 220 of the cellular network. The media transmission module 214 then opens another socket and binds it with the local IP address 220 of the WLAN, which may then be used for transmitting media associated with the call. In some embodiments, the media is not bound to a specific IP address 220, but rather the operating system 208 may change the IP address 220 of the socket. Binding involves the assignment of an IP address and port to a socket by the operating system 208. The socket listens to the IP/Port for packets and sends the packets through the IP/Port. In some embodiments, a socket may be configured with no address (0.0.0.0) but still be configured with a specific port, meaning that the address that the socket listens on is the address known to the NIC 218.

The network analysis/routing module 216 listens for notifications of a change in the network. When the network analysis/routing module 216 receives a notification from the operating system 208 that the WLAN has changed, the network analysis/routing module 216 opens a new socket bound to the new IP address 220 for the new WLAN. In some instances, depending on the network address translation (NAT) between the two endpoints of the call, signaling may be needed to inform the other endpoint that it needs to send media to a new address, as is known in the art. If no WLAN is available, the network analysis/routing module 216 transmits the media over the cellular network, for example, until it receives a notification that a WLAN is available. At such time, the network analysis/routing module 216 opens a socket and binds it to the IP address 220 of the newly-available WLAN. As such, the call signaling information continues to be transmitted over the cellular network, while the media is transmitted over the WLAN when available.

In some embodiments, the mobile app 210 may not wait for notifications from the operating system 208, but rather may bind the media to a new network based on pre-defined criteria. For example, if no packet is received from the originating IP address for X ms, the network analysis/routing module 216 may bind to a cellular network until a new WLAN network is found or until the network analysis/routing module 216 receives a new connectivity notification from the operating system 208. Alternatively, the mobile app 210 may bind the signaling and/or media to a new cellular network based on known connectivity strength of each cellular network at a geographic location. For example, if the signaling and/or media is on a 4G network, but the 4G network at the current geographic location is known to be unstable while the 3G network is known to be stable, the mobile app 210 may bind the signaling and/or media to a new network, for example to the more stable 3G network. In yet another example, the mobile app 210 may monitor different connections to find a connection with a higher bandwidth and/or lower packet loss and bind to a new network based on the connections. Lastly, the mobile app 210 may enable a user to manually change the connection to a new network.

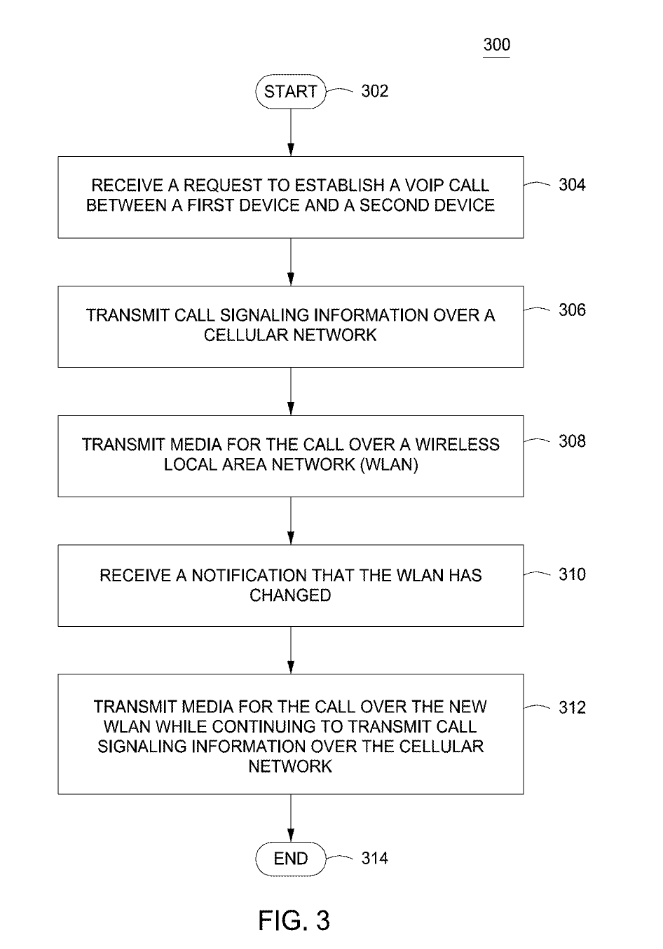

FIG. 3 depicts a flow diagram of a method 300 for controlling media and signaling channels of a Voice over Internet Protocol (VoIP) telephony communication, according to one or more embodiments of the subject invention. The method 300 starts at step 302 and proceeds to step 304, where a call request is received by the mobile app 210. The call request is a request to establish a VoIP call session between the mobile device 200 and second device (e.g.,136B).

At step 306, call signaling information is transmitted over a cellular network, or similar type of network that is considered to be always on or almost always on, to establish the call between the mobile device 200 and the second device. The mobile app 210 sends a request to the operating system 208 asking for all IP addresses it currently has through the network interface cards (NICs) 218. The operating system has Application Programming Interfaces (APIs) that can be used to extract the network IP addresses and the name of each. From each name, it can be understood whether the network is a WLAN or cellular. The signaling module 212 opens a socket and binds the socket to the IP address of the cellular network (e.g., 3G, 4G, LTE) to enable transmission of the call signaling information on the cellular network.

At step 308, media associated with the call between the mobile device 200 and the second device is transmitted over a wireless local area network (WLAN). The media transmission module 214 opens a socket and binds the socket to an IP address of the WLAN received from the operating system to enable transmission of the media on the WLAN.

At step 310, the mobile app receives a notification that the WLAN has changed. The network analysis/routing module may set a listener that intercepts notifications from the operating system when the network changes. Upon receipt of the notification, the network analysis/routing module may poll the operating system for the current IP addresses to determine whether they have changed.

At step 312, the network analysis/routing module transmits media associated with the call over the new wireless local area network (WLAN). The network analysis/routing module 216 opens a socket and binds the socket to the IP address of the new WLAN it received from the operating system. The network analysis/routing module may then transmit the media on the new network, while the call signaling information continues to be transmitted over the first network.

In some embodiments, the network analysis/routing module may receive information regarding the quality of the cellular network connection. In the event that the quality of the cellular network connection drops below a predefined threshold, or is not present at all, the network analysis/routing module may transmit the call signaling information via the WLAN. When the cellular network connection is restored, the network analysis/routing module may then return transmission of the call signaling information to the cellular network.

Conversely, in the event that a WLAN is no longer available, the network analysis/routing module may transmit the media for the call over the cellular network. When the network analysis/routing module receives a notification that a WLAN has become available, the network analysis/routing module may poll the operating system for the current IP addresses and then open a media transport by binding a socket to the IP address of the newly available WLAN.

The method 300 ends at step 314.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java.RTM, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

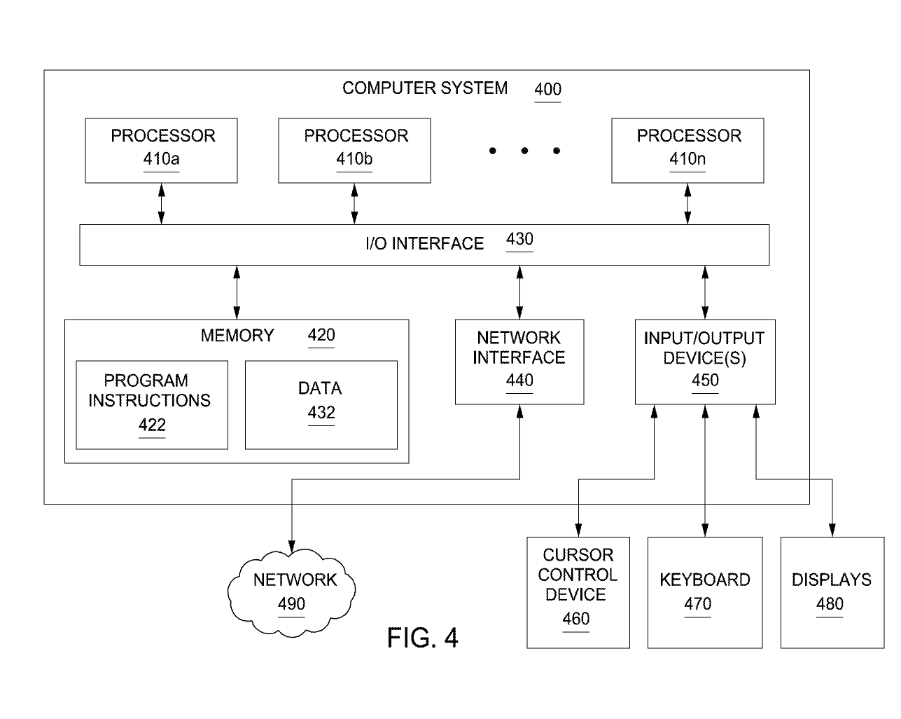

FIG. 4 depicts a computer system 400 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement the method 300 as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, and one or more input/output devices 450, such as cursor control device 460, keyboard 470, and display(s) 480. In various embodiments, any of the components may be utilized by the system to receive user input described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments, some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the operations and methods described above, such as the methods illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for controlling media and signaling channels of a Voice over Internet Protocol (VoIP) telephony communication, according to one or more embodiments, comprising:
transmitting call signaling information over a first network to establish a call between a first device and a second device;
transmitting media associated with the call between the first device and the second device over a second network, wherein the first network is different from the second network;
determining a third network is available for telephony communications; and
transmitting the media associated with the call between the first device and the second device over the third network while the call signaling information continues to be transmitted over the first network.

2. The method of claim 1, wherein the first network is a cellular network.

3. The method of claim 1, wherein the second network is one of a cellular network or a wireless local area network.

4. The method of claim 1, wherein the third network is one of a cellular network or a wireless local area network, the third network being different from the second network.

5. The method of claim 1, wherein transmitting call signaling information comprises:
selecting an Internet protocol (IP) for a cellular network on which to transmit the call signaling information; and
binding a socket for the call signaling information to a selected IP address.

6. The method of claim 1, wherein transmitting media comprises:
selecting an Internet protocol (IP) address of a wireless local area network on which to transmit the media associated with the call; and
binding a socket for the media to a selected IP address.

7. The method of claim 1, further comprising:
determining a connection quality of the first network falls below a predefined threshold;
transmitting call signaling information over the third network;
determining the connection quality of the first network exceeds the predefined threshold;
binding a socket for the call signaling information to an IP address of the first network; and
transmitting the call signaling information over the first network.

8. An apparatus for forwarding data packets containing media over a voice over Internet protocol (VoIP) communication, comprising:
a signaling module configured to transmit call signaling information over a first network to establish a call between a first device and a second device;
a media transmission module configured to transmit media associated with the call between the first device and the second device over a second network, wherein the first network is different from the second network, and to determine a third network is available for telephony communications; and
a network analysis/routing module configured to transmit the media associated with the call between the first device and the second device over the third network while the call signaling information continues to be transmitted over the first network.

9. The apparatus of claim 8, wherein the first network is a cellular network.

10. The apparatus of claim 8, wherein the second network is one of a cellular network or a wireless local area network.

11. The apparatus of claim 8, wherein the third network is one of a cellular network or a wireless local area network, the third network being different from the second network.

12. The apparatus of claim 8, wherein the signaling module is configured to transmit call signaling information by selecting an Internet protocol (IP) for a cellular network on which to transmit the call signaling information and bind the call signaling information to a selected IP address and wherein the media transmission module is configured to transmit media by selecting an Internet protocol (IP) address of a wireless local area network on which to transmit the media and binding a socket for the media to a selected IP address.

13. The apparatus of claim 8, wherein the network analysis/routing module is further configured to:
determine a connection quality of the first network falls below a predefined threshold;
transmit call signaling information over the third network;
determine the connection quality of the first network exceeds the predefined threshold;
bind a socket for the call signaling information to an IP address of the first network; and
transmit the call signaling information over the first network.

14. A non-transitory computer readable medium for storing computer instructions that, when executed by at least one processor causes the at least one processor to perform a method for controlling media and signaling channels of a Voice over Internet Protocol (VoIP) telephony communication, according to one or more embodiments, comprising:
transmitting call signaling information over a first network to establish a call between a first device and a second device;
transmitting media associated with the call between the first device and the second device over a second network, wherein the first network is different from the second network;
determining a third network is available for telephony communications; and
transmitting the media associated with the call between the first device and the second device over the third network while the call signaling information continues to be transmitted over the first network.

15. The computer readable medium of claim 14, wherein the first network is a cellular network.

16. The computer readable medium of claim 14, wherein the second network is one of a cellular network or a wireless local area network.

17. The computer readable medium of claim 14, wherein the third network is one of a cellular network or a wireless local area network, the third network being different from the second network.

18. The computer readable medium of claim 14, where transmitting call signaling information comprises:
selecting an Internet protocol (IP) for a cellular network on which to transmit the call signaling information; and
binding a socket for the call signaling information to a selected IP address.

19. The computer readable medium of claim 14, where transmitting media comprises:
selecting an Internet protocol (IP) address on which to transmit the media associated with the call; and
binding a socket for the media to a selected IP address.

20. The computer readable medium of claim 14, further comprising:
determining a connection quality of the first network falls below a predefined threshold;
transmitting call signaling information over the third network;
determining the connection quality of the first network exceeds the predefined threshold;
binding a socket for the call signaling information to an IP address of the first network; and
transmitting the call signaling information over the first network.
